(19) United States
(12) Patent Application Publication
(10) Pub. No.: US 2015/0207613 A1
(43) Pub. Date: Jul. 23, 2015

(54) APPARATUS FOR TIME DIVISION DUPLEX SWITCHING IN LTE MACHINE TYPE COMMUNICATION

(71) Applicant: Humax Holdings Co., Ltd., Yongin-si (KR)

(72) Inventors: Alex Chungku YIE, Incheon (KR); Yongjae LEE, Seongnam-si (KR); Jun Bae AHN, Gwangju-si (KR)

(21) Appl. No.: 14/603,078

(22) Filed: Jan. 22, 2015

(30) Foreign Application Priority Data
Jan. 23, 2014 (KR) 10-2014-0008371
May 16, 2014 (KR) 10-2014-0058952
May 16, 2014 (KR) 10-2014-0058953
May 16, 2014 (KR) 10-2014-0058954
Jul. 14, 2014 (KR) 10-2014-0088517
Jul. 14, 2014 (KR) 10-2014-0088519
Jan. 22, 2015 (KR) 10-2015-0010868

(51) Int. Cl. H04L 5/14; H04J 11/00; H04W 56/00; H04W 4/00

(52) U.S. Cl. CPC H04L 5/14; H04W 4/005; H04J 11/00; H04W 56/0045; H04W 88/06

(57) ABSTRACT

The present invention relates to a way of performing time division duplex switching with large intervals. An apparatus for time division duplex switching in LTE machine type communication which performs switching using an element with a low switching speed includes a machine type communication module that performs machine type communication with a base station.

### BACKGROUND OF THE INVENTION

1. Field of the Invention

Exemplary embodiments of the present invention relate to an apparatus for time division duplex switching in LTE machine type communication. In more detail, exemplary embodiments of the present invention relate to an apparatus for time division duplex switching in LTE machine type communication which performs switching using an element with a low switching speed.

2. Description of the Related Art

Machine-to-machine communication known as MTC (Machine Type Communication) uses a plurality of wireless communication units such as a 3G/4G communication network including a WLAN and LTE for a wireless terminal and provides an information service on a mobile wireless terminal from a service server through the wireless communication units.

In the MTC, a person is not necessary, there are a large number of latent terminals communicating with a server, and less traffic is used for each of the terminals. For example, the MTC may be used for remote measurement and control and e-health. Accordingly, one of the terms that are considered in 3GPP LTE is to manufacture an MTC terminal at a low cost.

However, using a low-cost MTC terminal may deteriorate timing exactness of an internal element. Further, an LTE system using a time division duplex (TDD) mode requires an exact signal timing, so using a low-cost MTC terminal may cause a transmission error in MTC.

Therefore, it is required to develop a switching method capable of preventing a timing error, even if a low-cost MTC terminal is used.

### DOCUMENTS OF RELATED ART

### Patent Document

Korean Patent Application Publication No. 10-2011-0072478 (Jun. 19, 2011)

### SUMMARY OF THE INVENTION

An object of the present invention is to provide an apparatus for time division duplex switching in LTE machine type communication which performs time division duplex switching with large intervals.

Another object of the present invention is to provide an apparatus for time division duplex switching in LTE machine type communication which can reduce the price of a machine type communication terminal by providing time division duplex switching that can be applied to an element with a low switching speed.

In accordance with an aspect of the present invention, a system for time division duplex switching in LTE machine type communication includes: a main base station that allocates a radio resource to a terminal and performs data communication with the terminal; a sub-base station that performs data communication with the terminal simultaneously with the main base station; and a terminal that performs data communication simultaneously with the main base station and the sub-base station and resets radio resource control when it is disconnected from the sub-base station.

When the terminal is not normally connected with the sub-base station, it transmits connection state information to the main base station.

The main base station transmits link state information between the sub-base station and the terminal to the sub-base station.

The main base station communicates with the sub-base station, using any one of an X2 interface, a broadband network, and a wireless backhaul.

The main base station includes a link state header, which shows at least any one of the link state between the main base station and the terminal and the link state between the sub-base station and the terminal, a link state, a base station ID, and a terminal ID as information in a frame in information transmitted/received to/from the sub-base station.

In accordance with another aspect of the present invention, an apparatus for time division duplex switching in LTE machine type communication includes a machine type communication module that performs machine type communication with a base station.

The machine type communication module may include: a transmitter that transmits data to the base station; a receiver that receives data from the base station; an antenna that is matched with the base station at an RF; and a switch that time-divisionally switches and connects the transmitter and the receiver with the antenna.

The switch of the machine type communication module may switch with the base station such that an uplink or a downlink are sequentially repeated at least two or more times.

The machine type communication module may repeat transmitting and receiving predetermined data on a sub-frame sequentially two or more times.

The machine type communication module may repeat transmitting and receiving any one item of data of predetermined data on a sub-frame.

The machine type communication module may sequentially transmit a PHICH to the base station two or more times.

The machine type communication module may repeat transmitting another channel of a sub-frame including a PHICH, together with the PHICH.

The system for time division duplex switching in LTE machine type communication according to the present invention can perform time division duplex switching with large intervals.

Further, the system for time division duplex switching in LTE machine type communication according to the present invention can reduce the price of a machine type communication terminal by performing switching using an element with a low switching speed.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating the configuration of an LTE network according to an exemplary embodiment of the present invention;

FIG. 2 is a diagram illustrating the configuration of dual connectivity when a first base station of FIG. 1 operates as a main base station and a second base station operates independently as a sub-base station;

FIG. 3 is a diagram illustrating the configuration of dual connectivity when the first base station of FIG. 1 operates as a main base station, the second base station operates as a sub-base station, and data is separated and combined through the main base station;

FIG. 4 is a diagram illustrating a configuration in detail when the sub-base station of FIGS. 2 and 3 is disconnected from a terminal;

FIG. 5 is a diagram illustrating a configuration in detail when transmission power for a terminal is allocated to the main base station or the sub-base station of FIGS. 2 and 3;

FIG. 6 is a diagram illustrating a configuration in detail when a terminal randomly accesses the main base station or the sub-base station of FIGS. 2 and 3.

FIG. 7 is a diagram illustrating the configuration of LTE machine type communication according to another exemplary embodiment of the present invention;

FIG. 8 is a diagram illustrating the configuration of an apparatus for time division duplex switching in LTE machine type communication according to the present invention;

FIG. 9 is a diagram showing an example of sequentially using two or more ULs and DLs by the machine type communication module of FIG. 7;

FIG. 10 is a diagram showing that demodulation is possible when the machine type communication module of FIG. 7 sequentially transmits and receives two PHICH; and

FIG. 11 is a block diagram illustrating a wireless communication system for which exemplary embodiments of the present invention can be achieved.

### DESCRIPTION OF SPECIFIC EMBODIMENTS

Detailed exemplary embodiments of the present invention will be described with reference to the accompanying drawings.

The present invention may be modified in various ways and implemented by various exemplary embodiments, so that specific exemplary embodiments are illustrated in the drawings and will be described in detail below. However, it is to be understood that the present invention is not limited to the specific exemplary embodiments, but includes all modifications, equivalents, and substitutions included in the spirit and the scope of the present invention.

Hereinafter, an apparatus for scheduling in LTE machine type communication according to the present invention is described in detail with reference to the accompanying drawings.

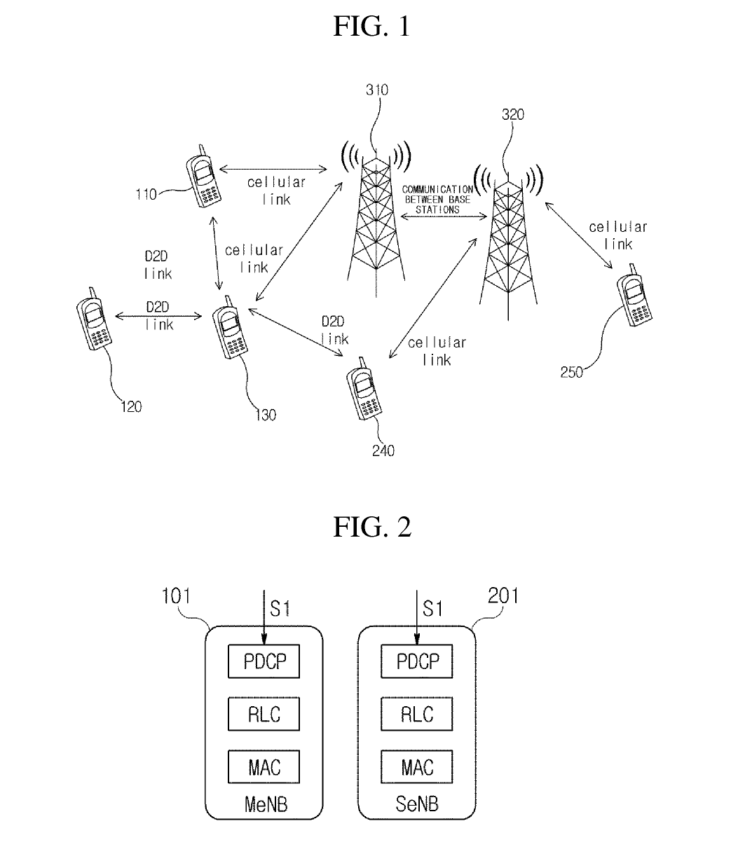

FIG. 1 is a diagram illustrating the configuration of an LTE network according to an exemplary embodiment of the present invention and FIGS. 2 to 6 are diagrams illustrating the configuration of FIG. 1 in detail.

An apparatus for scheduling in LTE machine type communication according to an exemplary embodiment of the present invention is described hereafter with reference to FIGS. 1 to 6.

Referring to FIG. 1 first, an LTE network structure according to an exemplary embodiment of the present invention is composed of base stations and terminals. In particular, new frequencies can be allocated and used for device-to-device communication, when a macrocell and a D2D channel are specifically allocated.

When a macrocell and a D2D channel are both allocated, device-to-device communication may be achieved by at least any one of adding a sub-channel and using the physical channel used by the macrocell, and at least any one of a channel allocation scheme, a channel management scheme, and a duplexing method may be used for interference between the macrocell and the D2D channel.

Further, synchronization between terminals may be provided from at least any one of an uplink, a downlink, and both of an uplink and a downlink.

In the LTE network structure, in detail, a first terminal 110 and a third terminal 130 are in the cellular link coverage of a first base station 310, and a fourth terminal 240 and a fifth terminal 250 are in the cellular link coverage of a second base station 320.

The third terminal 130 is positioned at a distance where D2D communication with the first terminal 110, the second terminal 120, and the fourth terminal 240 is available. The D2D link of the third terminal 130 and the first terminal 110 is in the same first base station 310, the D2D link of the third terminal 130 and the fourth terminal 240 is on another cellular coverage, the D2D link of the third terminal 130 and the second terminal 120 is formed by the second terminal 120 not positioned in any cellular coverage and the third terminal 130 positioned in the cellular coverage of the first base station 310.

The cellular link channel used between the first base station 310 and the third terminal 130 and the D2D link channel used by the third terminal 130 and the fourth terminal 240 may be separately or simultaneously allocated.

For example, when the cellular link channel used between the first base station 310 and the third terminal 130 and the D2D link channel used by the third terminal 130 and the fourth terminal 240 use the same frequency, OFDM symbols of PDSCH, PDCCH, PUSCH, and PUCCH may be separately allocated.

In particular, the first base station 310 can carry out an allocation schedule of time slots for transmitting a synchronization signal, a discovery signal, and an HARQ for the D2D link channel used by the third terminal 130 and the fourth terminal 240.

The synchronization signal transmitted by the first base station 310 may be used simultaneously with the information about the cellular link of the first base station 310, but the time slots for transmitting a synchronization signal, a discovery signal, and an HARQ for the third terminal 130 and the fourth terminal 240 may be scheduled not to overlap the time slots of the cellular link channels used between the first base station 310 and the third terminal 130.

When the cellular link channel used between the first base station 310 and the third terminal 130 and the D2D link channel used by the third terminal 130 and the fourth terminal 240 use different frequencies, the third terminal 130 and the fourth terminal 240 can exclusively use the OFDM symbols of PDSCH, PDCCH, PUSCH, and PUCCH, and the third terminal 130 or the fourth terminal 240 can perform scheduling.

D2D communication between the third terminal 130 and the fourth terminal 240 is performed, avoiding interference influenced by the first base station 310 and the first terminal 110. In particular, in the D2D communication between the third terminal 130 and the fourth terminal 240, the third terminal 130 uses any one of a way of transmitting a synchronization signal received from the first base station 310 to the fourth terminal 240 through the uplink channel used by the first base station 310, a way of transmitting the synchronization signal to the fourth terminal 240 through the downlink channel used by the first base station 310, and a way of transmitting the synchronization signal to the fourth terminal 240 through both of the uplink and downlink channels used by the first base station 310.

FIG. 2 is a diagram illustrating a configuration of dual connectivity when the first base station 310 of FIG. 1 operates as a main base station 101 and the second base station 320 operates independently as a sub-base station 201.

The main base station 101 (master eNB) and the sub-base station 201 (secondary eNB), which are used for dual connectivity, are individually connected with a core network.

Accordingly, all of protocols are independent from the main base station 101 and the sub-base station 201, and particularly, data to be transmitted to two base stations is not separated and combined at the base stations.

A PDCP (Packet Data Convergence Protocol) is one of wireless traffic protocol stacks in LTE which compresses and decompresses an IP header, transmits user data, and keeps a sequence number for a radio bearer.

RLC (Radio Link Control) is a protocol stack of controlling wireless connection between a PDCP and MAC.

MAC (Media Access Control) is a protocol stack supporting multi access on a radio channel.

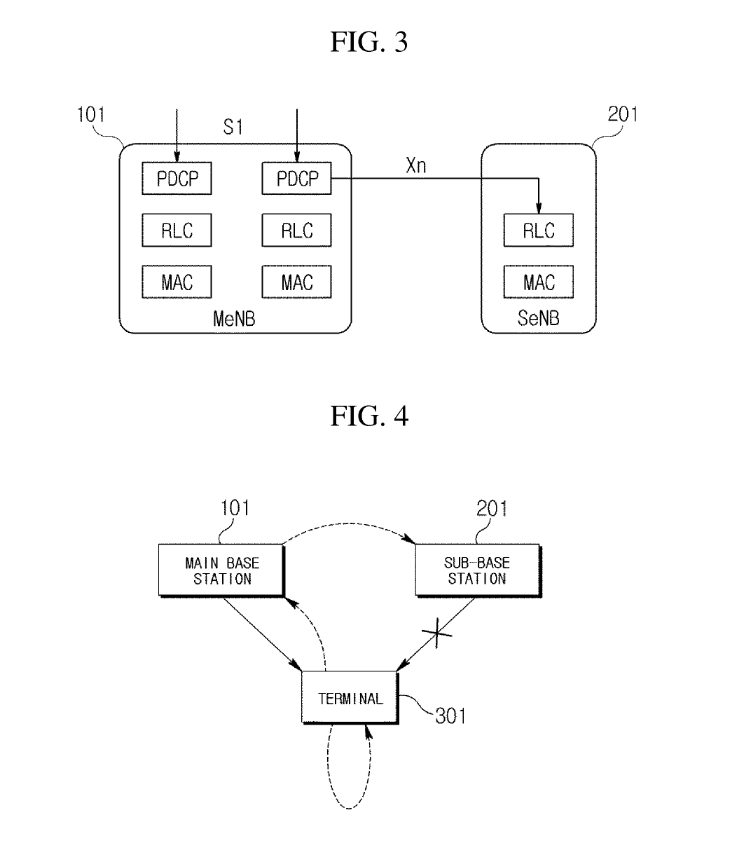

FIG. 3 is a diagram illustrating a configuration of dual connectivity when the first base station 310 of FIG. 1 operates as a main base station 101, the second base station 320 operates as a sub-base station 201, and data is separated and combined through the main base station 101.

That is, when the main base station 101 and the sub-base station 201, which are used for dual connectivity, are connected with a core network, only the main base station 101 is connected with the core network and the sub-base station 201 is connected with the core network through the main base station 101.

Accordingly, data transmitted/received on the core network is separated and combined by the main base station 101. That is, data separated from the main base station 101 is transmitted to the sub-base station 201 or data received from the sub-base station 201 is combined and transmitted/received on the core network.

FIG. 4 is a diagram illustrating a configuration in detail when the sub-base station 201 of FIGS. 2 and 3 is disconnected from a terminal 301.

That is, the system for scheduling in LTE machine type communication includes the main base station 201 that allocates a radio resource to the terminal 301 and performs data communication with the terminal 301, the sub-base station 201 that performs data communication with the terminal 301 simultaneously with the main base station 201, and the terminal 301 that simultaneously performs data communication with the main base station 101 and the sub-base station 201, and resets radio resource control (RRC) when it unlinks from the sub-base station 201.

When the terminal 301 is not normally connected with the sub-base station 201, it can inform the main base station 101 of connection state information. Further, the main base station 101 can inform the sub-base station 201 of link state information between the sub-base station 201 and the terminal 301.

Similarly, when the terminal 301 is abnormally connected with the main base station 101, the terminal 301 resets radio resource control and reports it to the sub-base station 201 and the sub-base station 201 reports the abnormal connection to the main base station 101.

The communication between the main base station 101 and the sub-base station 201 may be performed by adding information to a frame in an X2 interface or by a broadband network, and when they are not connected by a wire, wireless backhaul may be used for the communication. A signal system including a link state header showing the link state of the main base station 101 and the sub-base station 201, a link state, a base station ID, and a terminal ID may be used for the information in the frame.

Accordingly, when there is a problem with connection in any one of the main base station 101 and the sub-base station 201, the terminal 301 reports it to any one of the main base station 101 and the sub-base station 201, which has no problem, and the base station receiving the report informs the base station with the problem with connection of the report so that the state of connection with the terminal 301 can be checked.

On the other hand, when there is a problem with connection in both of the main base station 101 and the sub-base station 201, similarly, the terminal 301 resets the radio resource control to allow for communication with the base stations.

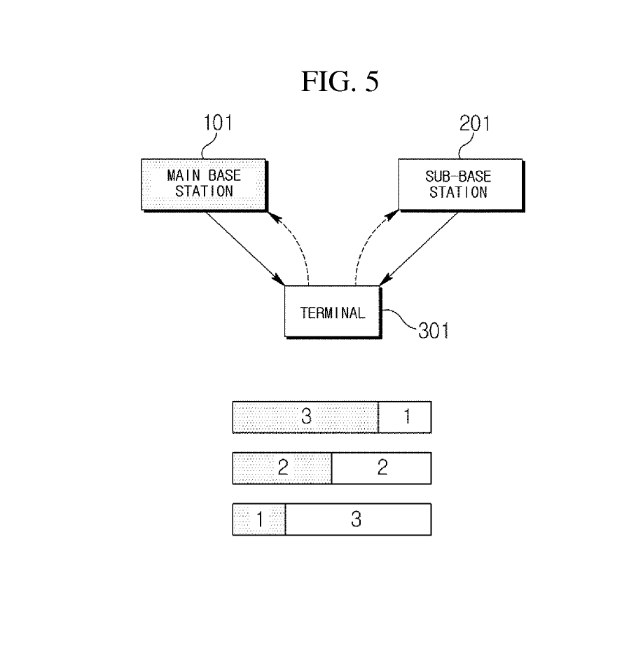

FIG. 5 is a diagram illustrating a configuration in detail when transmission power for the terminal 301 is allocated to the main base station 101 or the sub-base station 201 of FIGS. 2 and 3.

That is, the system for scheduling in LTE machine type communication includes the main base station 101 that allocates a radio resource to the terminal 301 and performs data communication with the terminal 301, the sub-base station 201 that performs data communication with the terminal 301 simultaneously with the main base station 101, and the terminal 301 that sets an upper limit ratio of transmission power for the main base station 101 and the sub-base station 201 on the basis of statistic analysis on power sent out from the main base station 101 and the sub-base station 201.

The statistic analysis is analyzing a transmission power ratio on the basis of the average power sent out from the terminal 301 to the main base station 101 and the sub-base station 201, and the terminal 301 reports the upper limit ratio of transmission power to the main base station 101 and the sub-base station 201.

That is, the terminal 301 sets the power ratio to send out to the main base station 101 and the sub-base station 201 on the basis of the average value of the maximum power, which can be sent out by the terminal 301, and the transmission values sent out to the main base station 101 and the sub-base station 201.

For example, it sets the ratio of power to send out to the main base station 101 and the sub-base station 201 as 3:1, 2:2, and 1:3.

As another example, when power to be sent is distributed, first, it is very important to maintain connectivity with the main base station 101 or transmit a control signal, so, in order to transmit the signal, power may be allocated to the main base station 101 first and then the remaining power may be distributed for data transmission/reception with the sub-base station 201.

As another example, the power available for transmitting data to the sub-base station 201 may be dynamically changed. That is, an MCS (Modulation and Coding Scheme) value may depend on the available power, even if the wireless channel does not change.

A data transmission error may be generated, when the power distribution and the MCS value are simultaneously changed, so that a change of the power distribution and a change of the MCS value may not be simultaneously performed.

Alternatively, when the power distribution and the MCS value are simultaneously changed, a period of reporting a CQI (Channel Quality Indicator) for changing the MCS, which is a feedback signal system, may be set not to be generated simultaneously with the change of the power distribution, in order to prevent a data transmission error.

On the other hand, at least any one of the maximum value of a terminal, the ratio of power that is being used, the maximum transmission power for each base station according to a power ratio, and the margin of the maximum power, which can be transmitted to the base stations, to the power currently sent out to the terminal can be reported to the main base station 101 and the sub-base station 201.

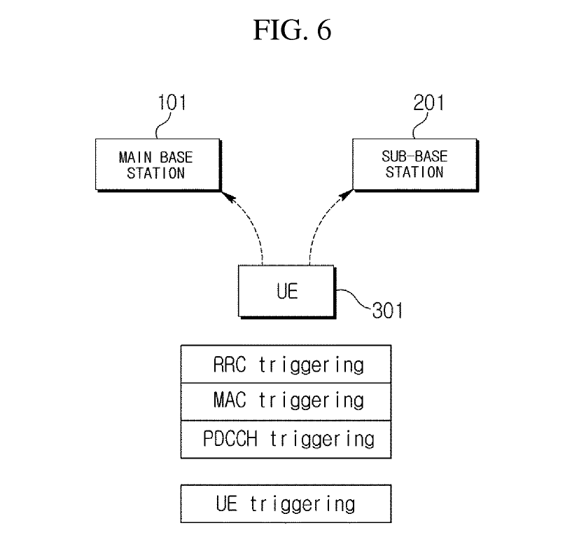

FIG. 6 is a diagram illustrating a configuration in detail when the terminal 301 randomly accesses the main base station 101 or the sub-base station 201 of FIGS. 2 and 3.

That is, the system for scheduling in LTE machine type communication includes the main base station 101 that allocates a radio resource to the terminal 301 and performs data communication with the terminal 301, the sub-base station 201 that performs data communication with the terminal 301 simultaneously with the main base station 101, and the terminal 301 that sends out any one of random access to the main base station 101 and the sub-base station 201 by triggering and self random access to them without triggering to at least any one of the main base station 101 and the sub-base station 201.

The triggering is performed by any one triggering command of PDCCH, MAC, and RRC and the sub-base station 201 includes a base station, which can be accessed first, of base stations that can operate as the sub-base station 201.

The random access is transmitted in any one type of a preamble without contents, initial access, a radio resource control message, and a terminal ID.

That is, the random access, which is used for initial access to the main base station 101 or the sub-base station 201, establishment and re-establishment of radio resource control, and handover, may be sent out to any one of the main base station 101 and the sub-base station 201 or simultaneously to the main base station 101 or the sub-base station 201.

Random access may be sent out by PDCCH, MAC, and RRC (Radio Resource Control) triggering from the main base station 101 or the sub-base station 201, but it may be sent out by triggering of a terminal itself.

Further, random access may be sent out by using the remaining power except for the power distributed to an uplink.

On the other hand, when the main base station 101 or the sub-base station 201 is newly turned on, an error may be generated in data communication due to simultaneous random access of surrounding terminals, including the terminal 301.

Accordingly, in order to reduce such influence, the terminal 301 may perform random access, additionally using a random time around ten seconds, when the main base station 101 or the sub-base station 201 is newly turned on. The ‘ten seconds’ is the maximum random access time that is variable in accordance with the number of terminals and the number of base stations and the maximum random access time may be any one in the range of one second to sixty seconds, depending on the environment.

Meanwhile, since the terminal 301 can use a multi-antenna, it is possible to minimize interference influence by finding the transmission position of the main base station 101 or the sub-base station 201 and performing random access toward the main base station 101 or the sub-base station 201.

Alternatively, when the exact positions of the main base station 101 and the sub-base station 201 are not found, the terminal 301 may perform random access by sweeping at 360 degrees.

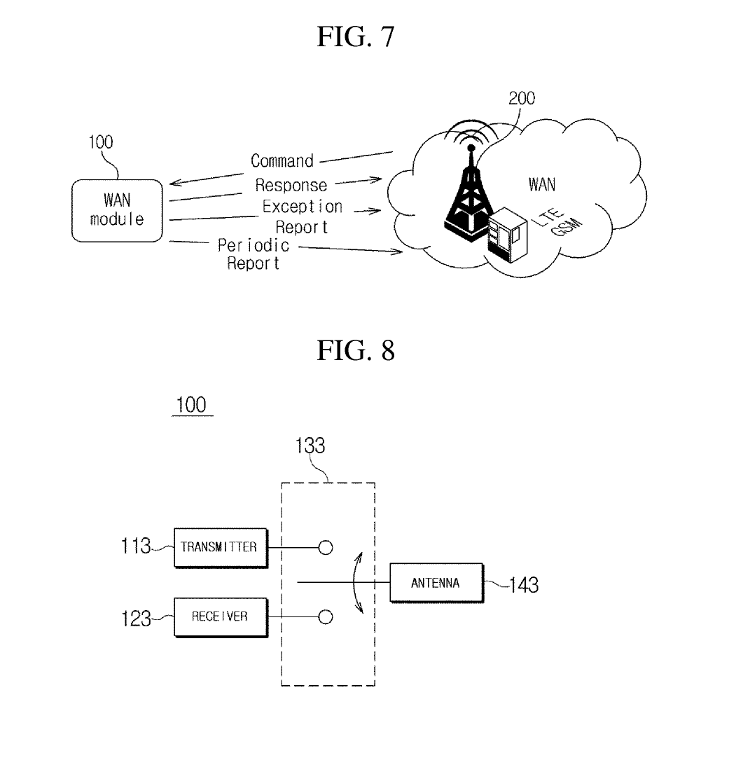

FIG. 7 is a diagram illustrating the configuration of LTE machine type communication according to another exemplary embodiment of the present invention.

When the third terminal 130 and the first base station 310 shown in FIG. 1 are operated as a machine type communication module 100 and a base station 200, respectively, in machine type communication, the machine type communication module 100 communicates with the base station 200 through a command-response, an exception report, and a periodic report.

The command-response is information provided from the machine type communication module 100 in response to a command by the base station 200, in which the command is made within 20 bytes, and the response is made within 100 bytes and within ten seconds.

The exception report is a report of information within 100 bytes provided from the machine type communication module 100 to the base station 200 within three to five seconds, when an event occurs, and the periodic report is a report of information provided within 100 bytes with predetermined intervals.

The machine type communication may transmit data not over 1,000 bytes, using one antenna, and may be made within a bandwidth of 1.4 MHz.

The machine type communication module 100 may use 25,344 bits for soft buffer for communication with the base station 200 and may activate an RF circuit, using one oscillator.

FIG. 8 is a diagram illustrating the configuration of an apparatus for time division duplex switching in LTE machine type communication according to the present invention. The apparatus for time division duplex switching in LTE machine type communication includes a base station 200 and a machine type communication module 100 that performs machine type communication.

The machine type communication module 100 may include a transmitter 113 that transmits data to the base station 200, a receiver 123 that receives data from the base station 200, an antenna 143 that is matched with the base station 200 at an RF, and a switch 133 that time-divisionally switches and connects the transmitter 113 and the receiver 123 with the antenna 143.

According to an embodiment, the machine type communication module 100 can be achieved as a low-cost/low-specification terminal in comparison to a legacy LTE terminal. In this case, a low-cost element with a long switching time in comparison to a high-specification switching element may also be used for the switch 133.

A 3GPP LTE TDD system can perform communication in the unit of a sub-frame including a downlink period and an uplink period. Accordingly, when the switching time of the machine type communication module 100 is long, the switching may cause a timing error in uplink/downlink communication through a sub-frame.

In order to solve this problem, according to an embodiment, the machine type communication module 100 can perform time division duplex switching with large intervals by switching with the base station 200 such that an uplink or a downlink are sequentially repeated at least two or more times. That is, the machine type communication module 100 can sequentially transmit uplink data two or more times through the transmitter 113 or sequentially receive downlink data two or more times through the receiver 123.

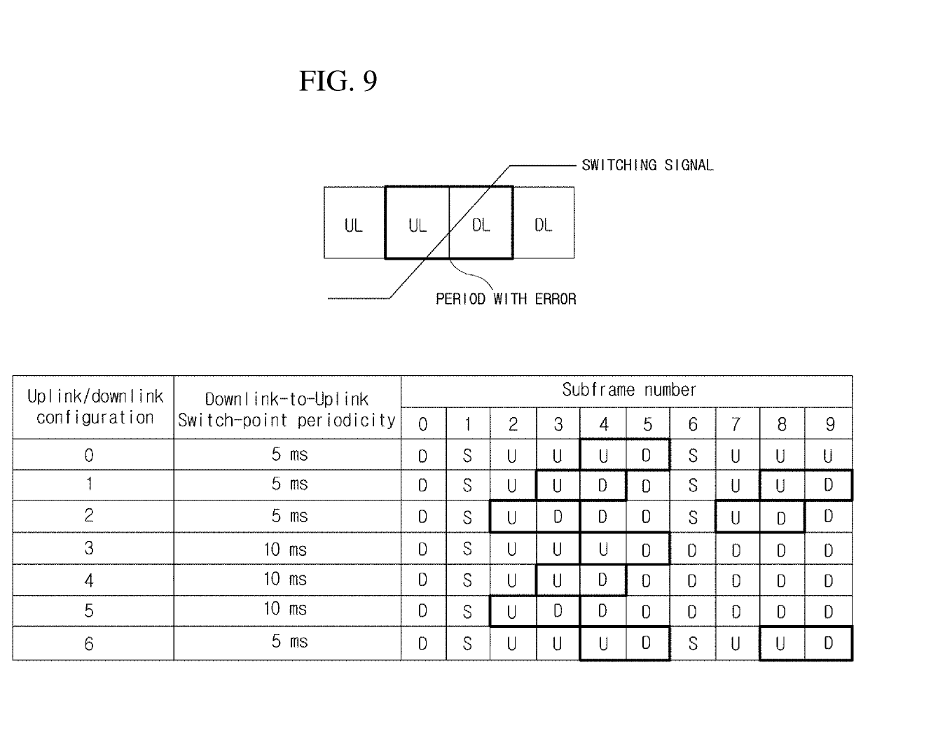

FIG. 9 is a diagram showing an example of sequentially using two or more ULs and DLs by the machine type communication module of FIG. 7.

The machine type communication module 100 can switch to repeat transmitting and receiving predetermined data on a sub-frame sequentially two or more times. For example, the machine type communication module 100 can repeat transmitting and receiving predetermined data ABC on a sub-frame in order of AABBCC or AAABBBCCC. In this case, even if ‘A’ at the front of a data sequence is not transmitted/received or ‘C’ at the rear of the data sequence is not transmitted/received due to long switching time, ‘ABC’ can be restored from the other transmitted/received data sequences, so a transmission error can be prevented.

When the switching time of the machine type communication module 100 is long, the possibility of an error is large in transmission and reception of the first one ‘A’ of the data ABC, so according to an embodiment, the machine type communication module 100 may repeat transmitting and receiving the first data in transmission/reception. For example, the machine type communication module 100 may repeat transmitting and receiving only the first data of predetermined data ABC on a sub-frame in the type of AABC or AAABC.

Further, the machine type communication module 100 may repeat transmitting and receiving any one item of data of predetermined data on a sub-frame.

With the time division duplex switching of the machine type communication module 100, the present invention can prevent a transmission error even if there is a timing difference due to a low switching speed.

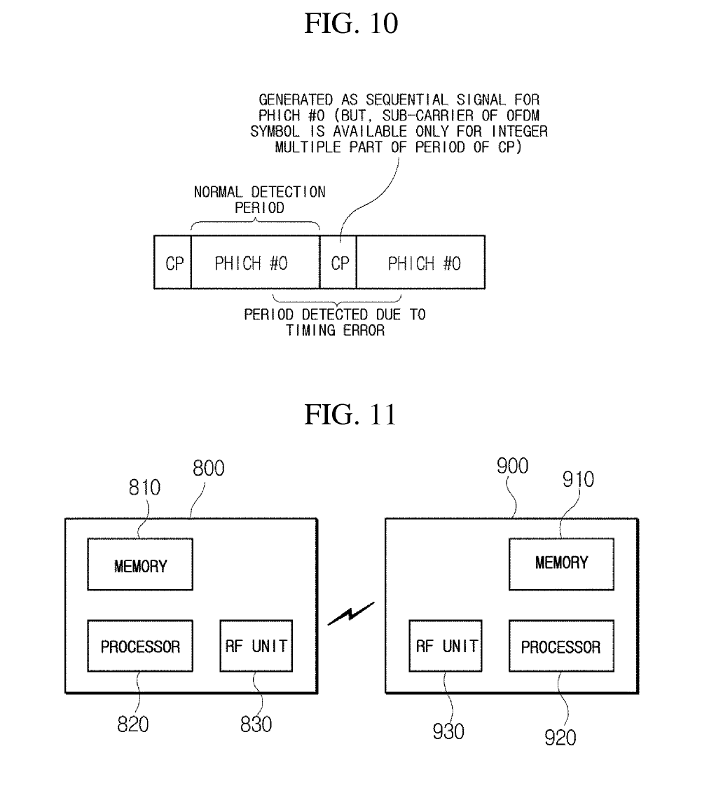

FIG. 10 is a diagram showing that demodulation is possible when the machine type communication module of FIG. 7 sequentially transmits and receives two PHICH.

A machine type communication module 100 according to another embodiment may sequentially transmit a PHICH (Physical HARQ indicator channel) two or more times to the base station 200.

The PHICH is used to transmit HARQ-ACK and is used to show whether a base station (for example, eNB) has exactly received UL-SCH (UL Shared Channel) data on a PUSCH (physical uplink shared channel).

That is, the transmitter 113 of the machine type communication module 100 can sequentially repeat transmitting the PHICH, which is a response channel of an HARQ, to the base station 200 two or more times.

When the PHICH is reliably transmitted, the HARQ can be normally operated. However, when a low-cost/low-specification machine type communication module 100 is used, a timing error may be caused by long switching time and the timing error may cause malfunction of an HARQ due to transmission failure of the PHICH. Accordingly, the machine type communication module 100 according to an embodiment allows for checking whether the base station 200 has exactly received UL-SCH data, even if there is a timing error, by transmitting two items of PHICH data.

In detail, a timing error of the machine type communication module 100 should not be out of a CP (Cyclic Prefix) that is a demodulation period exactness of OFDM (Orthogonal Frequency Division Multiplexing). However, when a timing error of the machine type communication module 100 is out of a CP, the PHICH cannot be demodulated, so an HARQ may not be normally executed.

However, when the PHICH is sequentially transmitted, data is not changed in the period of the CP, even if there is the same timing error, so the base station 200 can exactly receive the PHICH. Accordingly, the machine type communication module 100 according to an embodiment of the present invention can successively demodulate a PHICH, even if a timing error is out of a CP.

Further, a channel (for example, a PCFICH (Physical Control Format Indicator Channel)) that is transmitted simultaneously with the PHICH through a sub-frame does not influence demodulation of the PHICH, when the same data is sequentially transmitted, so the base station 200 can perform reliable demodulation of a PHICH. That is, the machine type communication module 100 can repeat transmitting another channel of a sub-frame including a PHICH, together with the PHICH.

According to this embodiment, the present invention can secure reliability of HARQ operation, even if a low-cost/low-specification machine type communication module is used.

FIG. 11 is a block diagram illustrating a wireless communication system for which exemplary embodiments of the present invention can be achieved. The wireless communication system shown in FIG. 10 may include at least one base station 800 and at least one terminal 900. A machine type communication module 100 may be considered as a kind of terminal 900 and a base station 200 that communicates with the machine type communication module 100 may also be considered as a base station 800 of the wireless communication system.

The base station 800 may include a memory 810, a processor 820, and an RF unit 830. The memory 810 is connected with the processor 820 and can keep commands and various terms of information for activating the processor 820. The RF unit 830 is connected with the processor 820 and can transmit/receive wireless signals to/from an external entity. The processor 820 can execute the operations of the base stations in the embodiments described above. In detail, the operations of the base stations 100, 101, and 201 etc. in the embodiments described above may be achieved by the processor 820.

The terminal 900 may include a memory 910, a processor 920, and an RF unit 930. The memory 910 is connected with the processor 920 and can keep commands and various terms of information for activating the processor 920. The RF unit 930 is connected with the processor 920 and can transmit/receive wireless signals to/from an external entity. The processor 920 can execute the operations of the terminals in the embodiments described above. In detail, the operations of the terminals 200, 300, 301, and 400 etc. in the embodiments described above may be achieved by the processor 920.

The present invention may be modified in various ways and implemented by various exemplary embodiments, so that specific exemplary embodiments are shown in the drawings and will be described in detail.

However, it is to be understood that the present invention is not limited to the specific exemplary embodiments, but includes all modifications, equivalents, and substitutions included in the spirit and the scope of the present invention.

Terms used in the specification, ‘first’, ‘second’, etc., may be used to describe various components, but the components are not to be construed as being limited to the terms. The terms are used to distinguish one component from another component. For example, the ‘first’ component may be named the ‘second’ component, and vice versa, without departing from the scope of the present invention. The term ‘and/or’ includes a combination of a plurality of items or any one of a plurality of terms.

It should be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, numerals, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

In one or more exemplary embodiments, the described functions may be achieved by hardware, software, firmware, or combinations of them. If achieved by software, the functions can be kept or transmitted as one or more orders or codes in a computer-readable medium. The computer-readable medium includes all of communication media and computer storage media including predetermined medial facilitating transmission of computer programs from one place to another place.

If achieved by hardware, the functions may be achieved in one or more ASICs, DSPs, DSPDs, PLDs, FPGAs, processors, controllers, microcontrollers, microprocessors, other electronic units designed to perform the functions, or combinations of them.

If achieved by software, the functions may be achieved by software codes. The software codes may be kept in memory units and executed by processors. The memory units may be achieved in processors or outside processors, in which the memory units may be connected to processors to be able to communicate by various means known in the art.

Although the present invention was described above with reference to exemplary embodiments, it should be understood that the present invention may be changed and modified in various ways by those skilled in the art, without departing from the spirit and scope of the present invention described in claims.

What is claimed is:

1. An apparatus for time division duplex switching in machine type communication, the apparatus comprising a machine type communication module that performs machine type communication with a base station,
wherein the machine type communication module includes:
a transmitter that transmits data to the base station;
a receiver that receives data from the base station;
an antenna that is matched with the base station at an RF; and
a switch that time-divisionally switches and connects the transmitter and the receiver with the antenna.

2. The apparatus of claim 1, wherein the switch of the machine type communication module switches with the base station such that an uplink or a downlink are sequentially repeated at least two or more times.

3. The apparatus of claim 2, wherein the machine type communication module repeats transmitting and receiving predetermined data on a sub-frame sequentially two or more times.

4. The apparatus of claim 2, wherein the machine type communication module repeats transmitting and receiving any one item of data of predetermined data on a sub-frame.

5. The apparatus of claim 1, wherein the machine type communication module sequentially transmits a PHICH (Physical HARQ Indicator Channel) to the base station two or more times.

6. The apparatus of claim 5, wherein the machine type communication module repeats transmitting another channel of a sub-frame including a PHICH, together with the PHICH.
